(19) United States
(12) Patent Application Publication
(10) Pub. No.: US 2011/0102272 A1
(43) Pub. Date: May 5, 2011

(54) Mobile Communication Device and Antenna Thereof

(76) Inventors: Kin-Lu Wong, Hsichih (TW); Fang-Hsien Chu, Hsichih (TW)

(21) Appl. No.: 12/715,461

(22) Filed: Mar. 2, 2010

(30) Foreign Application Priority Data
Nov. 5, 2009 (TW) 098137619

(51) Int. Cl. H01Q 9/04; H01Q 1/24; H01Q 5/00

(52) U.S. Cl. 343/702; 343/700 MS

(57) ABSTRACT

The present invention is related to a mobile communication device comprising a ground plane and an antenna. The antenna is disposed on one surface of a dielectric substrate. The antenna comprises a first radiating metal portion and a second radiating metal portion. The first radiating metal portion has at least one bending. One end of the first radiating metal portion is a feeding point of the antenna and the other end is left open. One end of the second radiating metal portion is short-circuited to the ground plane, and the other end is left open. A length of the second radiating metal portion is 0.75 to 1.25 times that of the first radiating metal portion. At least a portion of the second radiating metal portion is extended along the first radiating metal portion with a gap of less than a specified distance therebetween.

### BACKGROUND OF THE INVENTION

1. Field of the Invention

The present invention relates to a mobile communication device and an antenna thereof, and more particularly, to a mobile communication device which is able to cover two wide operating bands and an antenna thereof.

2. Description of the Related Art

With the evolution of wireless communication technologies, the wireless communication industry is developing vigorously. Mobile communication devices are designed to be lighter, thinner, shorter, and smaller, and to integrate multiband operations; therefore, mobile communication devices must use antennas which have smaller sizes and planar shapes, and which are able to operate in multiple frequency bands.

Prior art technique such as Taiwan patent NO. I308408, entitled “An Antenna Device for Mobile Phone,” discloses a three-dimensional mobile phone antenna which is bulky and occupies a lot of space; also, the antenna cannot fully cover the eight operating bands, namely LTE700/GSM850/900/1800/1900/UMTS/LTE2300/2500 required by LTE (Long Term Evolution) and WWAN (Wireless Wide Area Network), and it is not suitable for slim mobile communication devices.

Therefore, it is necessary to provide a mobile communication device and an antenna thereof to solve the problems presented in the prior art techniques.

### SUMMARY OF THE INVENTION

It is an object of the present invention to provide a mobile communication device comprising an antenna which can generate two wide operating bands.

It is another object of the present invention to provide an antenna which can generate two wide operating bands.

In order to achieve the above objects, the present invention discloses a mobile communication device comprising a ground plane and an antenna, the antenna having a first operating band and a second operating band, the antenna being disposed on one surface of a dielectric substrate, wherein the antenna comprises: a first radiating metal portion and a second radiating metal portion, the first radiating metal portion comprising at least one bending, the first radiating metal portion having a first end acting as a feeding point of the antenna and a second end left open; and the second radiating metal portion having a first end short-circuited to the ground plane and a second end left open, the second radiating metal portion having a length which is 0.75 to 1.25 times that of the first radiating metal portion, and the second radiating metal portion having at least one portion extending along the first radiating metal portion with a gap of less than a specified distance therebetween; hence, the second radiating metal portion is excited by the first radiating metal portion by capacitive coupling, the first radiating metal portion having a lower-frequency resonant mode combined with a lower-frequency resonant mode of the second radiating metal portion in the first operating band of the antenna, and the first radiating metal portion having a higher-order resonant mode combined with a higher-order resonant mode of the second radiating metal portion in the second operating band of the antenna.

In order to achieve another object of the present invention, the present invention discloses an antenna comprising: a first radiating metal portion and a second radiating metal portion, wherein the first radiating metal portion comprises at least one bending; the first radiating metal portion has a first end acting as a feeding point of the antenna and a second end left open; and the second radiating metal portion has a first end short-circuited to the ground plane and a second end left open; the second radiating metal portion has a length which is 0.75 to 1.25 times that of the first radiating metal portion, and the second radiating metal portion has at least one portion extending along the first radiating metal portion with a gap of less than a specified distance therebetween; hence, the second radiating metal portion is excited by the first radiating metal portion by capacitive coupling, the first radiating metal portion having a lower-frequency resonant mode combined with a lower-frequency resonant mode of the second radiating metal portion in the first operating band of the antenna, and the first radiating metal portion having a higher-order resonant mode combined with a higher-order resonant mode of the second radiating metal portion in the second operating band of the antenna.

According to one of the embodiments of the present invention, the gap is less than 3 mm; and the ground plane is a system ground plane of a mobile phone.

### BRIEF DESCRIPTION OF THE DRAWINGS

FIG. 1 illustrates a structural view of a first embodiment of a mobile communication device of the present invention;

FIG. 2 illustrates a diagram of a measured return loss of the first embodiment of the mobile communication device of the present invention;

FIG. 3 illustrates a structural view of a second embodiment of the mobile communication device of the present invention;

FIG. 4 illustrates a structural view of a third embodiment of the mobile communication device of the present invention; and

FIG. 5 illustrates a structural view of a fourth embodiment of the mobile communication device of the present invention.

### DETAILED DESCRIPTION OF THE PREFERRED EMBODIMENT

The advantages and innovative features of the invention will become more apparent from the following detailed description when taken in conjunction with the accompanying drawings.

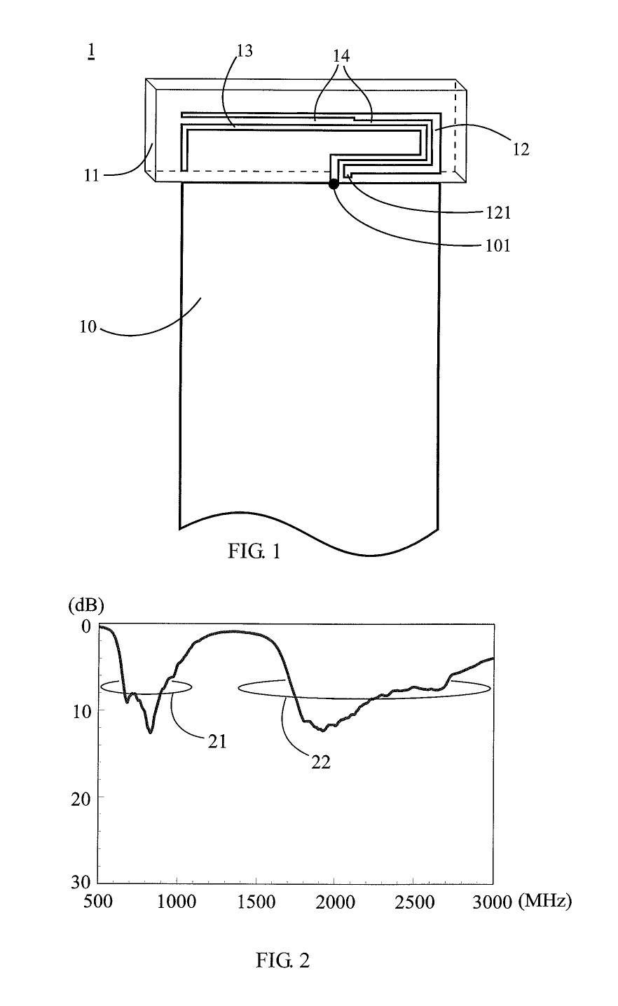

FIG. 1 illustrates a structural view of a first embodiment of a mobile communication device of the present invention. A mobile communication device 1 comprises a ground plane 10 and an antenna; the antenna is disposed on one surface of the dielectric substrate 11 and is adjacent to the ground plane 10. The antenna comprises a first radiating metal portion 12 and a second radiating metal portion 13. The first radiating metal portion 12 comprises at least one bending; the first radiating metal portion 12 has one end acting as an antenna feeding point 121 of the antenna and another end left open. The second radiating metal portion 13 has one end short-circuited to a ground point 101 of the ground plane 10 and another end left open. The length of the second radiating metal portion 13 is 0.75 to 1.25 times that of the first radiating metal portion 12. The first radiating metal portion 12 is close to the second radiating metal portion 13 with a gap 14 disposed therebetween. In other words, at least one portion of the second radiating metal portion 13 extends along the first radiating metal portion 12 with a gap 14 of less than a specified distance to generate a capacitive coupling; meanwhile, the first radiating metal portion 12 and the second radiating metal portion 13 are disposed on the same surface of the dielectric substrate 11. In this embodiment, the gap 14 is of variable value and is not equidistant; however, the width of the gap 14 must be less than 3 mm at any point to generate a sufficient capacitive coupling and to cause the second radiating metal portion 13 to be excited by the first radiating metal portion 12 by capacitive coupling. The variable width of the gap 14 can be used to adjust the capacitive coupling between the first radiating metal portion 12 and the second radiating metal portion 13 so as to achieve impedance matching of the antenna.

Since the first radiating metal portion 12 and the second radiating metal portion 13 have similar lengths, the two radiating metal portions 12, 13 can effectively excite a quarter-wavelength resonant mode (around 700 MHz and 900 MHz) in the lower band of the antenna respectively to be combined into the first operating band covering at least 698 MHz to 960 MHz, and the two radiating metal portions 12, 13 can also generate a higher-order resonant mode (around 1700 MHz and 2600 MHz) respectively to be combined into the second operating band covering at least 1710 MHz to 2690 MHz. The first operating band can cover the three frequency bands of LTE700/GSM850/900, and the second operating band can cover the five frequency bands of GSM1800/1900/UMTS/LTE2300/2500; therefore, the antenna can achieve operation in eight frequency bands, and the mobile communication device can cover all mobile communication frequency bands currently in use. Moreover, due to the capacitive coupling between the first radiating metal portion 12 and the second radiating metal portion 13, the antenna can be printed on the dielectric substrate 11 and occupies a smaller area on the dielectric substrate 11; the antenna is also simple in structure, easy to manufacture, and suitable for practical applications.

FIG. 2 illustrates a diagram of a measured return loss of the first embodiment of the mobile communication device of the present invention. In the first embodiment, the dielectric substrate 11 is a glass fiber dielectric substrate with a width of about 60 mm, a length of about 15 mm, and a thickness of about 0.8 mm; the ground plane 10 has a length of about 100 mm, and a width of about 60 mm; the first radiating metal portion 12 and the second radiating metal portion 13 are formed on the dielectric substrate 11 by printing or etching, wherein the first radiating metal portion 12 is about 96 mm long, the second radiating metal portion 13 is about 100 mm long, and the gap between the first radiating metal portion 12 and the second radiating metal portion 13 is less than about 1.5 mm at any point. From experimental results, with the definition of 6-dB return loss, the bandwidth of the first operating band 21 is formed by combining two resonant modes and can cover the three frequency bands of LTE700/GSM850/900 (69˜960 MHz); the second operating band 22 is also formed by combining two resonant modes and can cover the five frequency bands of GSM1800/1900/UMTS/LTE2300/2500 (1710˜2690 MHz).

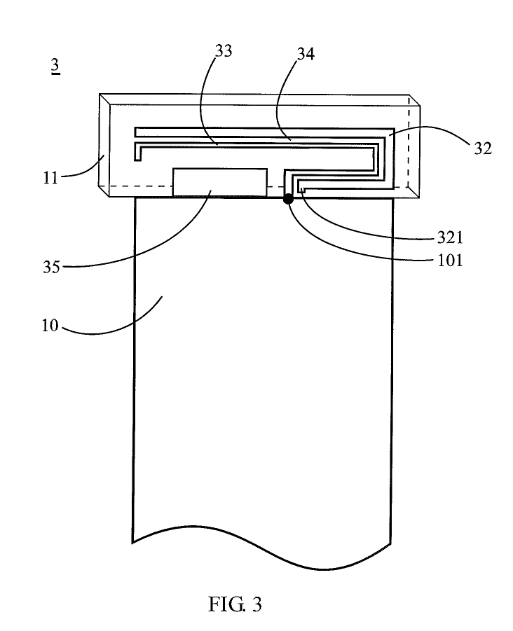

Please refer to FIG. 3 for a structural view of a second embodiment of the mobile communication device of the present invention. The mobile communication device 3 comprises the ground plane 10 and the antenna; the antenna is disposed on one surface of the dielectric substrate 11. The antenna comprises a first radiating metal portion 32 and a second radiating metal portion 33. The first radiating metal portion 32 has one end acting as a feeding point 321 of the antenna and another end left open; the gap 34 between the first radiating metal portion 32 and the second radiating metal portion 33 is of a fixed value and less than 3 mm.

In this embodiment, the dielectric substrate 11 has a shorting metal portion 35 disposed thereon; the shorting metal portion 35 is electrically connected to the ground plane 10 to extend the size of the ground plane 10. The implementation of the shorting metal portion 35 can effectively increase the circuit layout space of the mobile communication device 3.

The rest of the structure of the second embodiment is similar to that of the first embodiment; due to the similar structure, the second embodiment can generate the same two wide operating bands as those in the first embodiment and covers the eight frequency bands of LTE/GSM/UMTS operation.

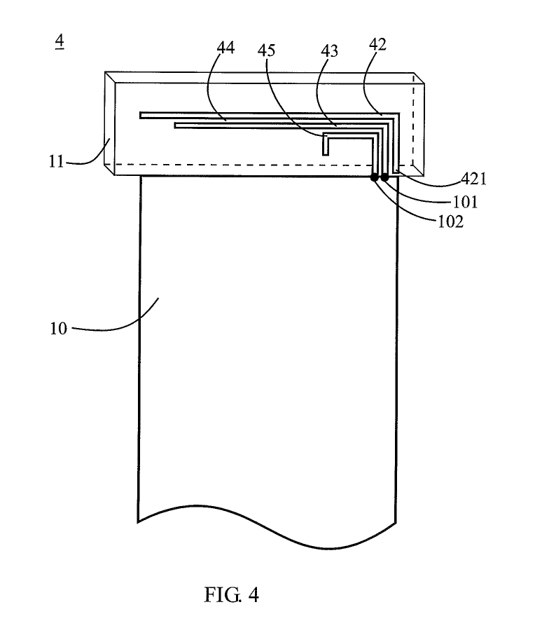

Please refer to FIG. 4 for a structural view of a third embodiment of the mobile communication device of the present invention. The mobile communication device 4 comprises the ground plane 10 and the antenna; the antenna is on one surface of the dielectric substrate 11. The antenna comprises a first radiating metal portion 42, a second radiating metal portion 43, and a third radiating metal portion 45. The third radiating metal portion 45 has one end short-circuited to a shorting point 102 of the ground plane 10 and another end left open. A portion of the third radiating metal portion 45 is extended along the second radiating metal portion 43 and is excited by the second radiating metal portion 43 by capacitive coupling, thereby generating a resonant mode to increase the operating bandwidth of the second operating band of the antenna. As described above, the third radiating metal portion 45 is designed to provide a resonant mode at a higher frequency band to increase the operating bandwidth of the antenna, so the length of the third radiating metal portion 45 can be modified to adjust the resonant frequency of this resonant mode; furthermore, there can be various ways to implement the bending to enable versatility in the design and to make it easy to adjust the impedance matching.

The rest of the structure of the third embodiment is similar to that of the first embodiment; for the similar structure, the third embodiment can achieve similar characteristics as those provided in the first embodiment.

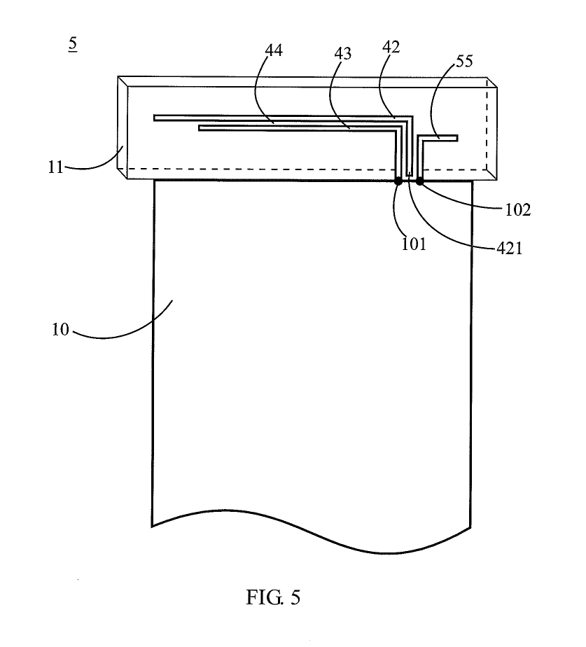

FIG. 5 illustrates a structural view of a fourth embodiment of the mobile communication device of the present invention. The mobile communication device 5 comprises the ground plane 10 and the antenna; the antenna is on one surface of the dielectric substrate 11. The antenna comprises the first radiating metal portion 42, the second radiating metal portion 43, and a third radiating metal portion 55. The third radiating metal portion 55 has one end short-circuited to the shorting point 102 of the ground plane 10 and another end left open. A portion of the third radiating metal portion 45 extends along the first radiating metal portion 42 and is excited by the first radiating metal portion 42 by capacitive coupling, thereby generating a resonant mode to increase the operating bandwidth of the second operating band of the antenna.

The rest of the structure of the fourth embodiment is similar to that of the first embodiment; due to the similar structure, the fourth embodiment can achieve characteristics similar to those provided in the first embodiment.

In the first and the second embodiments, the first radiating metal portion and the second radiating metal portion are slightly U-shaped; in the third and fourth embodiment, the first radiating metal portion and the second radiating metal portion are slightly L-shaped. The different implementations of the bending correspond to different sizes of the dielectric substrate 11. For example, the radiating metal portion can be formed in a slightly U-shaped structure if the size of the dielectric substrate 11 is reduced, or the radiating metal portion can be formed in a slightly L-shaped structure if the size of the dielectric substrate 11 is increased.

In the first and the second embodiments, the second radiating metal portion is longer than the first radiating metal portion; while in the third and fourth embodiments, the second radiating metal portion is shorter than the first radiating metal portion. The differences in the embodiments serve the following purpose. The resonant frequencies of the resonant modes and the covered frequency bands can be adjusted by modifying the lengths of the first radiating metal portion and the second radiating metal portion; therefore, for different substrates, the lengths of the first radiating metal portion and the second radiating metal portion can be adjusted accordingly.

As described above, the present invention discloses a mobile communication device having a planar monopole antenna which can generate two wide operating bands; the antenna has a simple structure and can be printed on a dielectric substrate or directly printed on a system circuit board of a mobile communication device to reduce the manufacturing cost; besides, the antenna is small (size less than 15×60 mm²) and has two operating bands which respectively support the three frequency bands of LTE700 (698˜787 MHz)/GSM850 (824˜894 MHz)/GSM900 (880˜960 MHz) and five frequency bands of GSM1800 (1710˜1880 MHz)/GSM1900 (1850˜1990 MHz)/UMTS (1920˜2170 MHz)/LTE2300 (2305˜2400 MHz)/LTE2500 (2500˜2690 MHz) to cover all mobile communication frequency bands currently in use, and the antenna is suitable for slim mobile communication devices.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A mobile communication device comprising a ground plane and an antenna, the antenna having a first operating band and a second operating band, the antenna being disposed on a dielectric substrate, wherein the antenna comprises:
a first radiating metal portion comprising at least one bending, the first radiating metal portion having a first end acting as a feeding point of the antenna and a second end left open; and
a second radiating metal portion having a first end short-circuited to the ground plane and a second end left open, the second radiating metal portion having a length which is 0.75 to 1.25 times that of the first radiating metal portion, and the second radiating metal portion having at least one portion extending along the first radiating metal portion with a gap of less than a specified distance therebetween;
whereby, the second radiating metal portion is excited by the first radiating metal portion by capacitive coupling, the first radiating metal portion having a lower-frequency resonant mode combined with a lower-frequency resonant mode of the second radiating metal portion in the first operating band of the antenna, and the first radiating metal portion having a higher-order resonant mode combined with a higher-order resonant mode of the second radiating metal portion in the second operating band of the antenna.

2. The mobile communication device as claimed in claim 1, wherein the gap is less than 3 mm.

3. The mobile communication device as claimed in claim 2, wherein the gap is of a variable value.

4. The mobile communication device as claimed in claim 2, wherein the gap is of a fixed value.

5. The mobile communication device as claimed in claim 1, wherein the first operating band covers the frequency band between 698 MHz and 960 MHz, and the second operating band covers the frequency band between 1710 MHz and 2690 MHz.

6. The mobile communication device as claimed in claim 1, wherein the ground plane is a system ground plane of a mobile phone.

7. The mobile communication device as claimed in claim 1, wherein the antenna comprises a third radiating metal portion having one end short-circuited to the ground plane; the third radiating metal portion is adjacent to the first radiating metal portion and is excited by the first radiating metal portion by capacitive coupling to generate a resonant mode to increase an operating bandwidth of the antenna.

8. The mobile communication device as claimed in claim 1, wherein the antenna comprises a third radiating metal portion having one end short-circuited to the ground plane; the third radiating metal portion is adjacent to the second radiating metal portion and is excited by the second radiating metal portion by capacitive coupling to generate a resonant mode to increase an operating bandwidth of the antenna.

9. The mobile communication device as claimed in claim 1, wherein the dielectric substrate comprises a shorting metal portion electrically connected to the ground plane.

10. An antenna for a mobile communication device having a ground plane, the antenna comprising:
a first radiating metal portion comprising at least one bending, the first radiating metal portion having a first end acting as a feeding point of the antenna and a second end left open; and
a second radiating metal portion having a first end short-circuited to the ground plane and a second end left open, the second radiating metal portion having a length which is 0.75 to 1.25 times that of the first radiating metal portion, and the second radiating metal portion having at least one portion extending along the first radiating metal portion with a gap of less than a specified distance therebetween;
whereby, the second radiating metal portion is excited by the first radiating metal portion by capacitive coupling, the first radiating metal portion having a lower-frequency resonant mode combined with a lower-frequency resonant mode of the second radiating metal portion in the first operating band of the antenna, and the first radiating metal portion having a higher-order resonant mode combined with a higher-order resonant mode of the second radiating metal portion in the second operating band of the antenna.
